(19) United States
(12) Patent Application Publication
(10) Pub. No.: US 2007/0109614 A1
(43) Pub. Date: May 17, 2007

(54) DOCUMENT FEEDER

(76) Inventors: Toshitaka Iwago, Nagoya-shi, Aichi (JP); Ryoichi Matsushima, Nagoya-shi, Aichi (JP); Yoichi Horaguchi, Nagoya-shi, Aichi (JP); Takashi Ohama, Nagoya-shi, Aichi (JP); Nobuhiko Suzuki, Nagoya-shi, Aichi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 11/554,662

(22) Filed: Oct. 31, 2006

(30) Foreign Application Priority Data
Oct. 31, 2005 (JP) 2005-317667

(51) Int. Cl. H04N 1/04

(52) U.S. Cl. 358/498; 358/488

(57) ABSTRACT

A document feeder includes: an inlet; an outlet; an input transfer path configured to guide a document during transfer from the inlet passed a scanning point to an end point positioned above the inlet; an intermediate transfer path configured to guide the document during transfer from the end point passed the scanning point to the end point again; an output transfer path configured to guide the document during transfer from the end point passed the scanning point to the outlet; a sensor disposed at downstream of the scanning point; and a controller determine whether the document transfer, based on the signal of the sensor.

### CROSS-REFERENCE TO THE RELATED APPLICATION

This application is based upon and claims priority from prior Japanese Patent Application No. 2005-317667 filed on Oct. 31, 2005, the entire contents of which are incorporated herein by reference.

### TECHNICAL FIELD

Illustrative aspects of the present invention relate to a document feeder suited for the double-sided reading of documents.

### BACKGROUND

In the prior art, in an image reading apparatus which is used in a copier, a scanner, a multi-function apparatus having the functions of the former is known to have an automatic document feeder called the ADF (Auto Document Feeder) for transferring the documents from an input tray through a transfer path to an output tray. There is also known an automatic document feeder for reading a document having its two first and second sides printed. In this device, the document is reversed at its leading end and trailing end by reversible rollers while it is being transferred (for example, see JF-A-8-85649).

FIG. 15 is a typical view of a feed path used in a conventional document feeder capable of reading both sides of a document. As shown in FIG. 15, a document P placed on a sheet feed tray 100 with the first surface (first page) thereof facing upward is fed to a feed path 102 by a sheet feed roller 101. In the feed path 102, the document P is fed to feed rollers 103 which are disposed properly according to cases. When the document P passes through a read position X, the first surface of the document P is read by an image read unit such as a CCD or a CIS. When a sensor detects the trailing end of the document P after the first surface thereof is read, sheet discharge rollers 104 are caused to stop in a state where the sheet discharge rollers 104 nip the vicinity around the trailing end of the document P.

As shown in FIG. 16, when the sheet discharge rollers 104 are reversed, the document P is fed to a bidirectional feed path 105. The document P is fed from the bidirectional feed path 105 again to a side upstream of the read position X. As a result, the leading and trailing ends of the document P are reversed. The document P is fed by the feed rollers 103, and when the document P passes through the read position X, the second surface of the document P is read by the image read unit. When a sensor detects the trailing end of the document P after the second surface of the document P is read, the sheet discharge rollers 104 are again stopped in a state where the trailing end of the document P is nipped. Afterwards, the document P is sent back along the bidirectional feed path 105. When the document F is moved from the bidirectional feed path 105 again into the feed path 102, the document P is held in a state where the leading and trailing ends of the document P are reversed once more, that is, the first surface of the document P is opposed to the read position X. The document P is delivered along the feed path 102 and is discharged into a sheet discharge tray 106 with the first surface thereof facing downward. As a result, both the first and second surfaces of the document P are read and the document P is discharged to the sheet discharge tray 106 in the order that the sheets of the document P were supplied to the sheet feet tray 100.

### SUMMARY

Aspects of the invention relate to a document feeder which is capable of feeding a document for double-sided reading and capable of discharging a document without damage or jam, even when a size of the document cannot b e applied to the double-sided reading.

Additional aspects of the invention relate to a document feeder including an inlet; an outlet; an input transfer path configured to guide a document during transfer from the inlet passed a scanning point to an end point positioned above the inlet; an intermediate transfer path configured to guide the document during transfer from the end point passed the scanning point to the endpoint again; an output transfer path configured to guide the document during transfer from the end point passed the scanning point to the outlet;a sensor disposed at downstream of the scanning point; and a controller determine whether the document transfer, based on the signal of the sensor.

### BRIEF DESCRIPTION OF THE DRAWINGS

These and other aspects of the present invention will be made more fully apparent from the following detailed description taken in conjunction with the accompanying drawings, in which:

FIG. 1 is a perspective view of the external structure of an image reading apparatus according to an aspect of the invention;

FIG. 2 is a sectional view of the internal structure of the image reading apparatus;

FIG. 3 is a block diagram of the structure of a control part;

FIG. 4 is a flow chart of the operation of a double-sided image reading mode;

FIG. 5 is a typical view of the image reading operation in the double-sided image reading mode;

FIG. 6 is a typical view of the image reading operation in the double-sided image reading mode;

FIG. 7 is a typical view of the image reading operation in the double-sided image reading mode;

FIG. 8 is a typical view of the image reading operation in the double-sided image reading mode;

FIG. 9 is a typical view of the image reading operation in the double-sided image reading mode;

FIG. 10 is a typical view of the image reading operation in the double-sided image reading mode;

FIG. 11 is a typical view of the image reading operation in the double-sided image reading mode;

FIG. 12 is a flow chart of an operation for judging the feed-direction length of a document;

FIG. 13 is a typical view of an operation for detecting a document using a second front sensor;

FIG. 14 is a typical view of an operation for discharging the document;

FIG. 15 is a typical view of a document feeding operation for reading the images of both sides of a document according to a conventional document feeder; and

FIG. 16 is a typical view of a document feeding operation for reading the images of both sides of a document according to a conventional document feeder.

### DETAILED DESCRIPTION

In the description that follows, various connections are set forth between elements in various overall structures. The reader should understand that those connections in general, and unless specified otherwise, may be direct or indirect and that this specification is not intended to be limiting in this respect.

Various examples of apparatuses in accordance with the invention will be described below with reference to the appended drawings. While the invention is described primarily in terms of “document”, this skilled in the art will appreciate, of course, that aspects and features of the invention may be used in conjunction with a wide variety of feeding systems and methods, including systems and methods for feeding other sheet type materials, such as plastics (e.g., transparencies), fiber materials, metals, flexible sheets, and the like

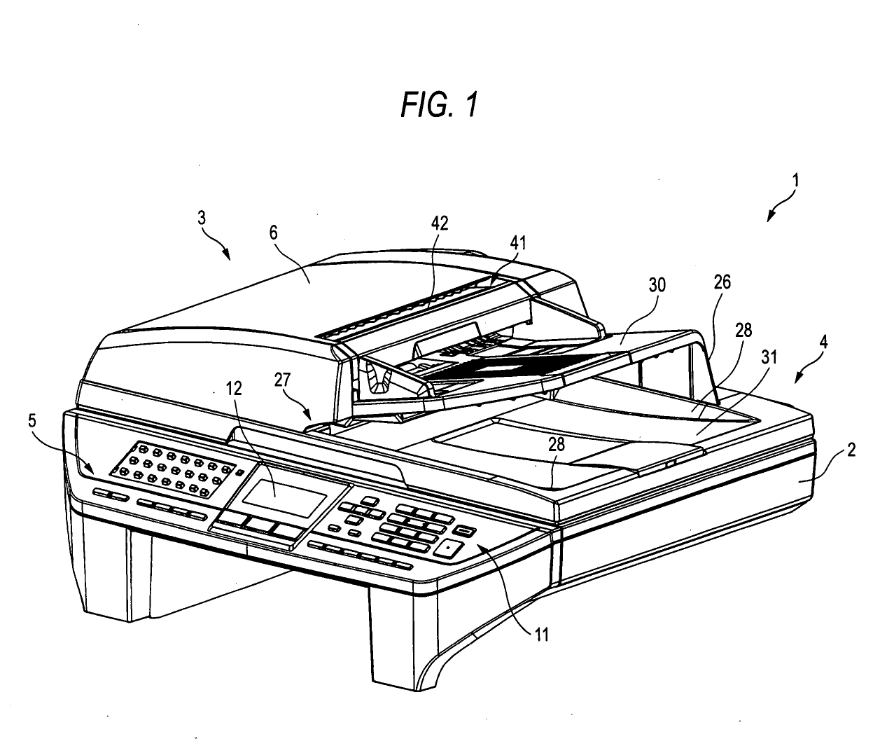

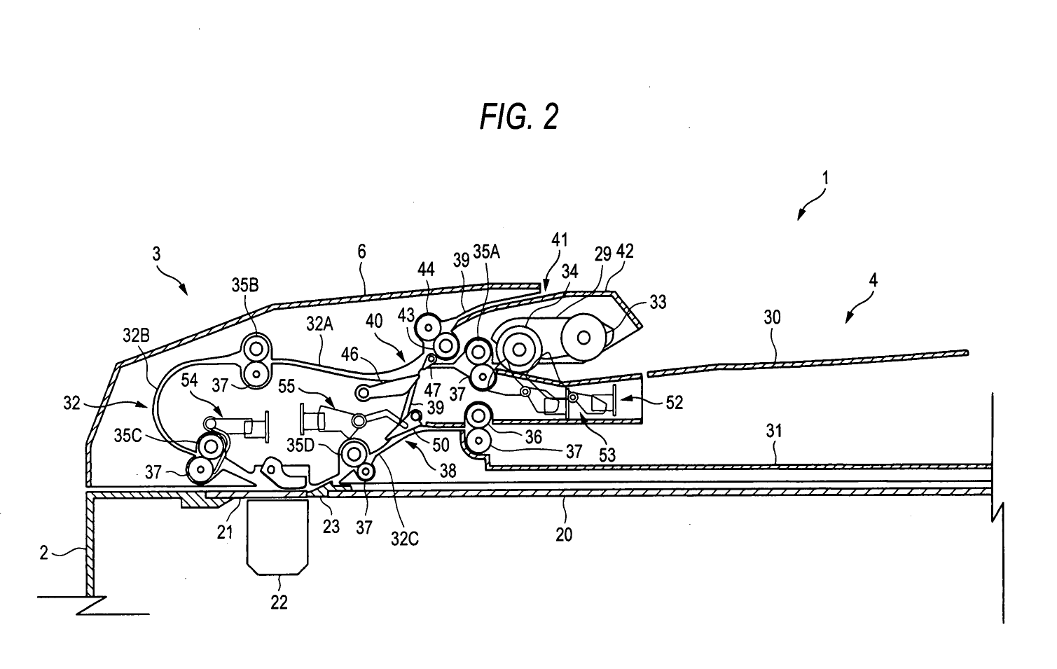

FIG. 1 shows the configuration of the image reading apparatus 1 according to the illustrative aspect of the invention. FIG. 2 shows the configuration of the main interior portions of the image reading apparatus 1. The present image reading apparatus 1 can be realized as an image read part which has a scanner function integrated therewith and used to read the image of a document, for example, in a copying machine, a facsimile, a scanner apparatus, and a multi-function device (MFD) having an integrated scanner function.

As shown in FIGS. 1 and 2, the present image reading apparatus 1 is structured such that a document cover 4 including an ADF 3 functioning as an automatic document feed mechanism is openably and closably mounted on a document placement base member 2 functioning as a flatbed scanner (FBS) through hinges provided on the back surface side (on the rear side in the depictions of the FIGS. 1 and 2). The ADF 3 corresponds to a document feeder according to the invention.

An operation panel 5 is disposed on the front side of the document placement base member 2. The operation panel 5 includes various operation keys 11 and a liquid crystal display part 12. A user can input a desired instruction using the operation panel 5. For example, the input of “Start” showing the commencement of reading a document and “Stop” showing the termination of such reading, as well as the choice of a one-sided reading mode or a double-sided reading mode can be carried out using the operation keys 11. On receiving these given inputs, the image reading apparatus 1 carries out a given operation. The image reading apparatus 1 can also be operated by instructions other than the instructions inputted to the operation panel 5. The image reading apparatus 1 can also be connected to a computer and thus can be operated by instructions which are transmitted thereto from the computer through a printer driver, a scanner driver, or the like.

As shown in FIG. 2, on the document placement base member 2, and more specifically, on the top surface thereof facing the document cover 4, there are disposed platen glass members 20, 21. When the document cover 4 is opened, the platen glass members 20, 21 are exposed as the top surface of the document placement base member 2. When the document cover 4 is closed, the whole of the top surface of the document placement base member 2 including the platen glass members 20, 21 is covered by the document cover 4. In the interior of the document placement base member 2, there is incorporated an image read unit 22 in such a manner as to be opposed to the platen glass members 20, 21.

The platen glass member 20 is a member on which a document can be placed when the image reading apparatus 1 is used as an FBS. For example, the platen glass member 20 may be composed of a transparent glass plate. In the center of the top surface of the document placement base member 2, there is formed an opening from which the platen glass member 20 can be exposed, whereby the area of the platen glass member 20 that is exposed from the opening provides a document read area in the FBS.

The platen glass member 21 functions as a read position when the ADF 3 of the image reading apparatus 1 is used, and as an example, may be composed of a transparent glass plate. In the read position of the document placement base member 2, there is formed an opening from which the platen glass member 21 can be exposed. The platen glass member 21 exposed from the opening is extended in the depth direction of the image reading apparatus 1 correspondingly to the length in the main scanning direction of the image read unit 22.

A positioning member 23 is interposed between the platen glass members 20 and 21. The positioning member 23 is a long flat-plate-shaped member which is extended in the depth direction of the image reading apparatus 1 similarly to the platen glass member 21. When a document is placed onto the platen glass member 20 serving as the document placement surface of the FBS, the positioning member 23 is used as the positioning reference of the document. For this purpose, on the top surface of the positioning member 23, there are disposed indications for indicating the position of the center as well as the positions of the two ends of various document sizes such as A4 size and B5 size. On the top surface of the positioning member 23, there is further formed a guide surface by which a document passing on the platen glass member 21 by the ADF 3 can be scooped up and deflected and also can be then returned to the ADF 3.

The image read unit 22 is an image sensor which radiates the light from a light source onto the document through the platen glass members 20, 21, gathers the reflected light from the document onto a light receiving element, and converts the light to an electric signal. The image read unit 22 can be formed of, for example, a close-contact type image sensor (CIS) or a charge coupled device (CCD) of a reduction optical system. The image read unit 22 is disposed such that it can be moved back and forth below the platen glass members 20, 21 by a belt drive mechanism functioning as a scanning mechanism. On receiving the drive force of a carriage motor, the image read unit 22 can be moved back and forth parallelly to the platen glass members 20, 21.

The document cover 4 includes the ADF 3 which successively feeds a document from a sheet feed tray 30 (a document placement portion) through a document feed path 32 to a sheet discharge tray 31 (a document discharge portion). In the feed process that is carried out by the ADF 3, the document passes through the read position on the platen glass member 21 and the images of the document can be read by the image read unit 22 which is located below the platen glass member 21.

As shown in FIGS. 1 and 2, on the document cover 4, there are disposed the sheet feed tray 30 and sheet discharge tray 31 in respective upper and lower stages, with the sheet feed tray 30 being situated in the upper stage. On the sheet feed tray 30, there can be placed a document the images of which are to be read by the ADF 3. Two or more sheets of documents are placed onto the sheet feed tray 30 in such a manner that they are piled on top of one another with the first surfaces thereof facing upward and the leading ends thereof in the sheet

feed direction are inserted into the document feed path 32. The apparatus back surface side of the sheet feed tray 30 is curved downward to thereby form a protection wall 26. The lower end of the protection wall 26 is connected to the top surface of the document cover 4. When the document cover 4 is opened with respect to the document placement base member 2, the protection wall 26 prevents the document on the sheet discharge tray 31 from falling down. Downward from the apparatus front surface side of the sheet feed tray 30, there is formed a cutaway portion 27 in a part of the body of the ADF 3. This cutaway portion 27 enhances 5 the visibility of the document from the apparatus front surface side when the document is discharged to the sheet discharge tray 31. Especially, a document of a small size is generally difficult to see due to the sheet feed tray 30. The cutaway portion 27 creates a space between the sheet feed tray 30 and sheet discharge tray 31 to thereby be able to enhance the visibility of a document, especially, that of a small-sized document.

The sheet discharge tray 31 is set below the sheet feed tray 30 while being spaced apart from the sheet feed tray 30 in the vertical direction, and the Sheet discharge tray 31 is formed integrally with the top surface of the document cover 4. Documents with images which have been read and which have been discharged from the ADF 3 are separated from documents existing on the sheet feed tray 30, and are piled on the sheet discharge tray 31 on top of one another with their first surfaces facing downward. The two side portions 28 of the sheet discharge tray 31, which are respectively composed of the apparatus front surface side and apparatus back surface side of the sheet discharge tray 31, are formed as slanting surfaces which gradually rise upwardly toward respective side. When the documents discharged to the sheet discharge tray 31 are to be out therefrom, while holding the documents from above, the documents can be slid along the slanting surfaces of the two side portions 28 and can be taken out, The two side portions 28 facilitate removal of the documents from the sheet discharge tray 31.

As shown in FIG. 2, in the interior of the ADF 3, in order to be able to connect together the sheet feed tray 30 and sheet discharge tray 31 through the read position on the platen glass member 21, there is formed the document feed path 32, the longitudinal section view of which has a substantially U-like shape facing sideways. The document feed path 32 is continuously formed by a member, a guide plate, a guide rib and the like respectively constituting the main body of the ADF 3, in the form of a path having a given width which allows the document to pass therethrough. In this manner, since the sheet feed tray 30 and sheet discharge tray 31 are disposed in the upper and lower stages and also since the document feed path 32 having a sideways facing, substantially U-shaped longitudinal section is formed so as to be able to connect the two trays together, the width of the ADF 3 can be narrowed and thus the size of the ADF 3 can be reduced.

The document feed path 32 is extended from the sheet feed tray 30 toward one end side (in FIG. 2, toward the left side) of the document cover 4, and is curved downward in a reversing manner to reach the read position on the platen glass member 21, and also extended from the read position toward the sheet discharge tray 31, whereby the longitudinal section view of the document feed path 32 has a substantially U-like shape facing sideways. The document feed path 32 is mainly composed of three portions, an upper portion 32A and a lower portion 32C which respectively constitute the straight line portions of the upper and lower stages forming the substantially U-like shape, and a curved portion 32B curved in such a manner so as to connect the upper and lower portions 32A and 32C. The document feed path 32 is used as a common document feed path through which the document can be fed by the ADF 3 not only when the images of one side of the document are read, but also when the images of both sides of the document are read.

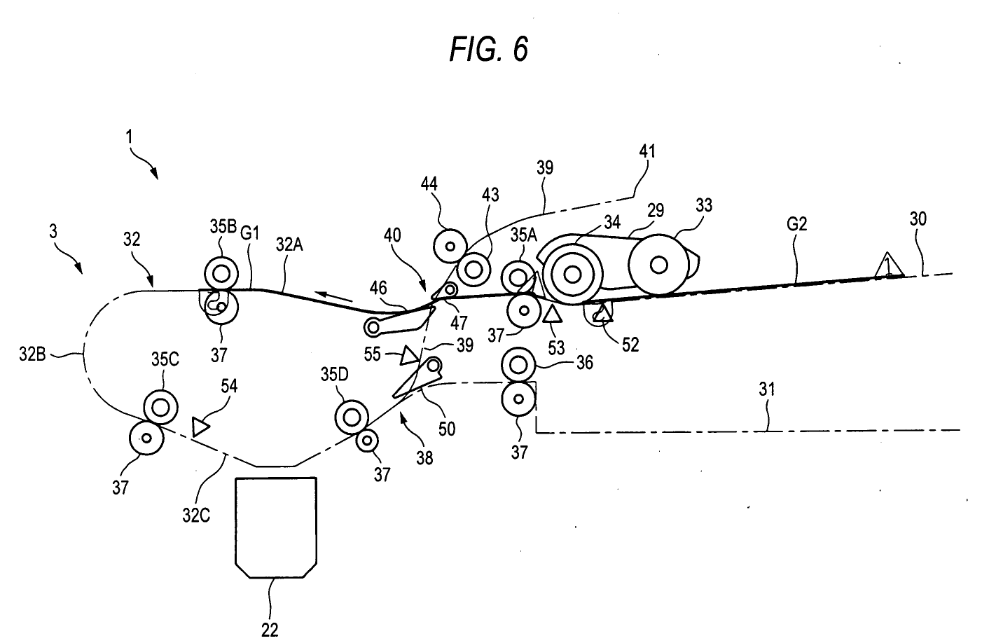

The document feed path 32 includes a feed unit for feeding documents existing on the sheet feed tray 30 to the document feed path 32 and a document feed unit for feeding the documents from the sheet feed tray 30 to the sheet discharge tray 31. In detail, as shown in FIG. 2, the feed unit is composed of a suction roller 33 and a separation roller 34 respectively provided in the document feed path 32, whereas the document feed unit is composed of feed rollers 35A, 35B, 35C, 35D, a sheet discharge roller 36, and respective pinch rollers 37 to be pressure contacted with the feed rollers 35A, 35B, 35C and 35D. A drive force is transmitted from a motor 67 (a drive source; see FIG. 6) to the respective rollers that constitute the feed unit and the document feed unit.

As shown in FIG. 2, the suction roller 33 and separation roller 34 are disposed in the neighborhood of the most upstream portion of the document feed path 32, that is, in the neighborhood of the sheet feed tray 30. The suction roller 33 is rotatably provided on the leading end portion of an arm 29 having its base end side pivotally supported on a shaft which pivotally supports the separation roller 34. The separation roller 34 is rotatably provided at a position spaced from the suction roller 33 in the sheet feed direction in such a manner that it is in contact with the opposed surfaces of the document feed path 32. When the drive force from the motor 67 is transmitted thereto, the suction and separation rollers 33 and 34 can be driven and rotated. The arm 29 can also be moved up and down when the drive force is transmitted thereto from the motor 67. The suction and separation rollers 33 and 34 have the same diameter and can be rotated at the same peripheral speed. At the opposite position of the separation roller 34, there is disposed a separation pad which can be pressure contacted with the roller surface of the separation roller 34 to separate the document by means of friction.

The feed rollers 35A, 35B, 35C and 35D are respectively disposed at different positions in the document feed path 32. According to the present aspect, the feed roller 35A is disposed on the immediate downstream sidle of the separation roller 34, the feed roller 35B is disposed in the upper portion 32A of the document feed path 32, the feed roller 35C is disposed on the immediate upstream side of the read position in the lower portion 32C of the document feed path 32, and the feed roller 35D is disposed on the immediate downstream side of the read position in the lower portion 32C of the document feed path 32. This arrangement is given an example, and the number and arrangement of the feed rollers 35A, 35B, 35C and 35D can be changed while still maintaining the spirit and scope of the invention.

At the respective opposite positions of the feed rollers 35A, 35B, 35C and 35D, there are disposed the pinch rollers 37. The shafts of the pinch rollers 37 are respectively elastically energized by their associated springs, whereby the pinch rollers 37 are respectively pressure contacted with the roller surfaces of the feed rollers 35A, 35B, 35C and 35D. When the feed rollers 35A, 3$B, 35C and 35D are rotated, the pinch rollers 37 pressure contacted with these rollers are also rotated to follow the feed rollers. The pinch rollers 37 respectively press the document against the feed rollers 35A, 35B, 35C and 35D to thereby transmit the rotation forces of the feed rollers 35A, 35B, 35C and 35D to the document.

The sheet discharge roller 36 is disposed in the neighborhood of the furthest downstream portion of the document feed path 32, and similar to the feed rollers 35A, 35B, 35C and 35D, when the drive force from the motor is transmitted to the sheet discharge roller 36, the sheet discharge roller 36 is driven and rotated. At the opposite position of the sheet discharge roller 36, there is also disposed a pinch roller 37, which is elastically energized by a spring and is thereby pressure contacted with the sheet discharge roller 36.

A bidirectional feed path 39 (a bidirectional feed path) is connected to a connecting position 38 in the lower portion 32C of the document feed path 32. The bidirectional feed path 39 is a path which, when reading both sides of the document, reverses the leading and trailing ends of the document with the first surface thereof read at the read position and then feeds again the document from the portion of the document feed path 32 downstream from the read position to the portion of the document feed path 32 upstream from the read position. The bidirectional feed path 39 is extended obliquely upward from the connecting position 38 toward the upper side of the sheet feed tray 30, and crosses the upper portion 32A of the document feed path 32. The document, which has been switchback-fed from a crossing position 40 between the upper portion 32A and bidirectional feed path 39, is then returned back to the document feed path 32.

The terminal end 41 of the bidirectional feed path 39 is opened on the top surface of the ADF 3. On the side of the sheet feed tray 30 that extends from the terminal end 41 of the bidirectional feed path 39, there is formed a document support portion 42 in such a manner that it extends from the lower guide surface of the terminal end 41. The document support portion 42 is used to support the document projected from the terminal end 41 of the bidirectional feed path 39, and forms the upper cover 6 (see FIG. 1) of the ADF 3 on the upper side of the feed roller 33 and separation roller 34. The upper cover 6 is formed so as to be able to cover the whole of the ADF 3 including the feed roller 33 and separation roller 34, while being able to be opened and closed. The document support portion 42, which is formed as a portion of the upper cover 6, is extended from the terminal end 41 toward the sheet feed tray 30 up to the upstream side of the sheet feed position to which the documents are fed by the sheet feed roller 33 and separation roller 34. Thanks to this structure, in the double-sided reading operation, a portion of the document which has entered the bidirectional feed path 39 and is projected from the terminal end 41 outwardly from the ADF 3, can be supported by the document support portion 41. Also, when the upper cover 6 is opened, the document feed path 32 and bidirectional feed path 39 within the ADF 3 are exposed in part, thereby enabling execution of a maintenance operation such as a jam removing operation.

On the side of the bidirectional feed path 39 that extends to the terminal end 41 from the crossing position 40, there is disposed a switchback roller 43. When a drive force is transmitted thereto from the motor 67, the switchback roller 43 can be driven and rotated in both forward and backward directions (a pulling direction and a returning direction). A pinch roller 44 is arranged at the opposing position of the switchback roller 43. Because the shaft of the pinch roller 44 is elastically energized by a spring, the pinch roller 44 is pressure contacted with the roller surface of the switchback roller 43, and as the switchback roller 43 is rotated, the pinch roller 44 is rotated to follow the switchback roller 43. The pinch roller 44 presses the document against the switchback roller 43, whereby the rotational force of the switchback roller 43 is transmitted to the document. The switchback roller 43 and pinch roller 44 cooperate together in realizing a bidirectional feed unit which bidirectional feeds the document. p As shown in FIG. 2, a guide flap 46 and a guide flap 47 which are used to guide a document to a desired feed path are disposed in the crossing position 40. The guide flap 46 is disposed such that it can be rotated in a given range about a corner portion between the read position side of the document feed path 32 and the connecting position 38 side of the bidirectional feed path 39 in the crossing position 40. The guide flap 46 is composed of a vane-shaped flat plate and the leading end of the guide flap 46 is projected into the crossing position 40. In FIG. 2, there is shown only one guide flap 46. However, two or more guide flaps 46 may be disposed having the same shape at given intervals in the width direction of the document feed path 32 (in FIG. 2, in the figure sheet vertical direction, or in the apparatus depth direction), and the two or more guide flaps 46 can be rotated integrally.

The guide flap 46 can be rotated upward in FIG. 2 form the position shown in FIG. 2. Also, the guide flap 46, for example, when it is contacted with a guide member provided in the document feed path 32 or in the bidirectional feed path 39, it is prevented from rotating downward in FIG. 2 from the position shown in FIG. 2. When the guide flap 46 is held at the position shown in FIG. 2, in the crossing position 40, the feed path from the sheet feed tray 30 side (in FIG. 2, the right side) of the document feed path 32 to the read position side (in FIG. 2, the left side) is allowed to be continuous, and at the same time, the feed path from the document feed path 32 to the connecting position 38 side (in FIG. 2, the lower side) of the is closed. Owing to this, a document, which has arrived at the crossing position 40 from the sheet feed tray 30 side of the document feed path 32, is allowed to advance to the read position side of the document feed path 32 and is prevented from entering the connecting position 38 side of the bidirectional feed path 39. Also, a document having arrived at the crossing position from the terminal end 41 side (in FIG. 2, the upper side) is allowed to enter the read position side of the document feed path 32 and is prevented from moving to the connecting position 38 side of the bidirectional feed path 39.

When the guide flap 46 is rotated, the feed path extending from the connecting position 38 side of the bidirectional feed path 39 to the terminal end 41 side is allowed to be continuous, whereas the feed path extending from the connecting position 38 side of the bidirectional feed path 39 to the read position side of the document feed path 32 is closed. As a result, the document, which has arrived at the crossing position 40 from the connecting position 38 side of the bidirectional feed path 39, is allowed to advance to the terminal end 41 side of the bidirectional feed path 39, whereas it is prevented from advancing to the read position side of the document feed path 32.

The switching of the feed path by the guide flap 46 is achieved by the contact of the document with the guide flap 46. The guide flap 46 is normally held at the position as shown in FIG. 2, due to its own weight or due to the energizing force of an elastic member such as a spring. When the document being delivered from the connecting position 38 toward the crossing position 40 along the bidirectional feed path 39 is contacted with the guide flap 46, the guide flap 46 is rotated in such a manner that it is pushed aside upwardly. On the other hand, the document being delivered from the terminal end 41 side of the bidirectional feed path 39 to the crossing position 40 is contacted with the guide flap 46, but since the guide flap 46 is prevented from rotating downward, the document is guided by the guide flap 46 to advance to the read position side along the upper portion 32A of the document feed path 32. As to the vane shape of the guide flap 46, there is employed a shape which not only can easily change the position of the guide flap 46 when it is contacted by the document being delivered from the connecting position 38 side of the bidirectional feed path 39 to the crossing position 40, but also allows the document being delivered from the terminal end 41 side of the bidirectional feed path 39 to the crossing position 40 to be easily guided to the read position side of the document feed path 32. In this manner, when the guide flap 46 is formed such that it is able to change its position due to the contact of the document with the guide flap 46, it is not necessary to change the position of the guide flap 46 positively by applying a drive force from the motor 67, which makes it possible to realize the guide flap 46 with a simple structure.

Now, the guide flap 47 is disposed in such a manner that it can be rotated in a given range about a shaft 49 provided in a corner portion between the sheet feed tray 30 side of the document feed path 32 and the terminal end 41 side of the bidirectional feed path 39. The guide flap 47 is composed of a flat plate having a vane-like shape, while the leading end of the guide flap 47 is projected into the crossing position 40. In FIG. 2, there is shown only one guide flap 47. However, two or more guide flaps 47 may disposed having the same shape at given intervals in the width direction of the document feed path 32, the two or more guide flaps 47 capable of being rotated together integrally.

When the guide flap 47 is rotated about the shaft 49, the position of the guide flap 47 can be changed from the position shown in FIG. 2. When the guide flap 47 is contacted with, for example, the guide members of the document feed path 32 or bidirectional feed path 39, the guide flap 47 is prevented from rotating to the right side (in FIG. 2) and is also prevented from rotating upward from the position shown in FIG. 2. When the guide flap 47 is in the position shown in FIG. 2, not only the feed path extending from the terminal end 41 side of the bidirectional feed path 39 to the read position side of the document feed path 32 is allowed to be continuous, but also the feed path extending from the connecting position 38 side of the bidirectional feed path 39 to the sheet feed tray 30 side of the document feed path 32 is closed. As a result, the document, which has arrived at the crossing position 40 from the terminal end 41 side of the bidirectional feed path 39, is allowed to advance to the read position side of the document feed path 32, whereas the document is prevented from advancing to the sheet feed tray 30 side. Also, the document having arrived at the crossing position 40 from the connecting position 38 side of the bidirectional feed path 39 is allowed to advance to the terminal end 41 side of the bidirectional feed path 39, whereas the document is prevented from advancing to the sheet feed tray 30 side of the document feed path 32.

On the other hand, when the guide flap 47 is rotated, not only the feed path from the sheet feed tray 30 side of the document feed path 32 to the read position side is allowed to be continuous, but also the feed path from the sheet feed tray 30 side of the document feed path 32 to the terminal end 41 side of the bidirectional feed path 39 is closed. As a result, the document, which has arrived at the crossing position 40 from the sheet feed tray 30 side of the document feed path 32, is allowed to advance to the read position side of the document feed path 32 but is prevented from advancing to the terminal end 41 side of the bidirectional feed path 39.

The switching of the feed path by the guide flap 47 is attained by the contact of the document with the guide flap 47. The guide flap 47 is normally held at at the position as shown in FIG. 2, due to its own weight or due to the energizing force of an elastic member such as a spring. When the document being delivered from the sheet feed tray 30 side of the document feed path 32 is contacted with the guide flap 47, the guide flap 47 is rotated in such a manner that it pushed aside to the left side (in FIG. 2). On the other hand, even if the document, which has been delivered from the connecting position 38 of the bidirectional feed path 39 to the crossing position 40, is contacted with the guide flap 47, because the guide flap 47 is prevented from rotating to the right side from the position as shown in FIG. 2, the document is guided by the guide flap 47 so as to advance to the terminal end 41 side of the bidirectional feed path 39. As to the vane shape of the guide flap 47, there is employed a shape which not only can easily change the position of the guide flap 47 when it is contacted by the document being delivered from the sheet feed tray 30 side of the document feed path 32 to the crossing position 40, but also allows the document being delivered from the connecting position 38 side of the bidirectional feed path 39 to the crossing position 40 to be easily guided to the crossing position 40 from the connecting position 38 of the bidirectional feed path 39. In this manner, when the guide flap 47 is formed such that it is able to change its position due to the contact of the document with the guide flap 47, it is not necessary to change the position of the guide flap 47 positively by applying a drive force from a motor or the like, which makes it possible to realize the guide flap 47 with a simple structure.

As shown in FIG. 2, a guide flap 50 (guide unit) is disposed in the connecting position 38. The guide flap 50 can be rotated about a position which intervenes between the document feed path 32 and bidirectional feed path 39, and when a drive force is transmitted from a motor 67 thereto, the guide flap 50 is rotated downward in FIG. 2 from the position shown in FIG. 2. The guide flap 50, for example, when it is contacted with a guide member provided in the document feed path 32 or in the bidirectional feed path 39, is prevented from rotating upward in FIG. 2 from the position shown in FIG. 2, and after it is rotated downward in FIG. 2 to a position for guiding the document to the bidirectional feed path 39, the guide flap 50 is also prevented from rotating further downward in FIG. 2. When the guide flap 50 is held at the position shown in FIG. 2, in the connecting position 38, the feed path from the read position side (in FIG. 2, the left side) to sheet discharge tray 31 side (in FIG. 2, the right side) is allowed to be continuous. Owing to, a document, which has passed through the read position, is guided in the connecting position 38 toward the sheet discharge tray 31 along the lower portion 32C of the document feed path 32. When the guide flap 50 is rotated downward in FIG. 2 from the position shown in FIG. 2, the feed path from downstream of the read position of the lower portion 32C of the document feed path 32 to the bidirectional feed path 39 is allowed to be continuous. Thus, a document having passed through the read position is guided along the connecting position 38 so as to enter the bidirectional feed path 39. Thus, the guide flap 50 is disposed in such a manner that, in the connecting position 38, it is able to guide the document to either the document feed path 32 or the bidirectional feed path 39. In FIG. 2, there is shown only one guide flap 50. However, two or more guide flaps 50 may be disposed having the same shape at given intervals in the width direction of the document feed path 32, while the two or more guide flaps 50 are to be rotated together as an integral body.

As shown in FIG. 2, two or more sensors which are used to detect the feeding of the document are provided in the document feed path 32 and bidirectional feed path 39. In detail, in the document feed path 32, a first front sensor 52 and a second front sensor 53 are disposed respectively on the upstream and downstream sides of the separation roller 34. A rear sensor 54 is arranged on the upstream side of the read position. A switchback sensor 55 is arranged between the connecting position 38 and crossing position 40 of the bidirectional feed path 39. These sensors are respectively so called optical sensors which are used to detect the rotational movements of detectors appearing and disappearing in the document feed path 32 or bidirectional feed path 39 in the form of the on/off of the photo-interrupters. Of these sensors, the second front sensor 53 corresponds to a document sensor according to the invention.

When, with the feed-direction leading end of the document in contact with the separation roller 34, the document is placed on the sheet feed tray 30, the first front sensor 52 is turned on. According to the on/off of the first front sensor 52, it can be detected whether the document is placed on the sheet feed tray 30 or not.

The second front sensor 53 disposed just downstream of the separation roller 34 is a sensor which, through its own on/off, can detect the feed-direction length of the document fed to the document feed path 32. The distance from the second front sensor 53 to the connecting position 38 of the document feed path 32 is longer than the feed-direction length of the document both sides of which can be read by the image reading apparatus 1. In other words, the second front sensor 53 is disposed at a position spaced from the connecting position 38 of the document feed path 32 toward the feed direction upstream side at least by an amount equivalent to the feed-direction length of the document both sides of which can be read. Therefore, when the feed-direction leading end of the document arrives at a given position upstream in the feed direction of the connecting position 38 of the document feed path 32, whether the second front sensor 53 detects the feed-direction trailing end side of the document or not can be used to settle whether the length of the document is longer than a given feed-direction length or not.

Whether both sides of a document can be read by the image reading apparatus 1 or not is judged by whether the document can be fed as a double-sided readable document by the ADF 3 or not. In the double-sided reading feed, a document having passed through the read position of the document feed path 32 is guided to the bidirectional feed path 39 and is switchback fed, whereby the document is returned from the crossing position 40 to the upstream side of the read position of the document feed path 32. When a document having a feed-direction length longer than the feed distance of a loop-shaped route extending from the crossing position 40 of the document feed path 32 through the read position, connecting position 38 and bidirectional feed path 39 in this order again to the crossing position 40 enters the bidirectional feed path 39 from the connecting position 38 of the document feed path 32 and arrives at the crossing position 40, there is a fear that the feed-direction leading end side of the document can be contacted with the feed-direction trailing end thereof to thereby cause inconveniences such as jammed sheets or damaged documents. Therefore, it is considered that a document having a feed-direction length longer than the above-mentioned loop-shaped feed distance cannot be fed as a double-sided readable document by the ADF 3. The use of the second front sensor 53 is not always limited to the detection of the feed-direction length of a document. For example, for registration of a document, the second front sensor 53 may be used to detect whether the feed-direction leading end of the document has arrived at the feed roller 35B or not; that is, the detect signal of the second front sensor 53 may be used together with the rotation amount of the motor 67 to judge whether such leading end has arrived or not.

The rear sensor 54 disposed just upstream of the read position is a sensor which, according to its own on/off, detects the leading and trailing ends of a document being fed along the document feed path 32. By monitoring the number of rotations of the feed rollers 35A, 35B, 35C and 35D after detection of the leading or trailing end of the document by the rear sensor 54 through the number of steps of the encoder or motor 67, it is judged whether the leading or trailing end of the document has arrived at a given position upstream in the feed direction of the read position or connecting position 38 or not. The image reading of the image read unit 22 is controlled according to the detect signal of the rear sensor 54. When the leading end of the document has arrived at the read position, the image reading is started, and when the trailing end of the document has arrived at the read position, the image reading is ended. Also, the timing for the second front sensor 53 to detect the presence or absence of a document in order to judge the feed-direction length of the document is the time when it is judged according to the detect signal of the rear sensor 54 that the feed-direction leading end of the document has arrived at a given position upstream in the feed direction of the connecting position 38.

The switchback sensor 55 interposed between the connecting position 38 and crossing position 40 of the bidirectional feed path 39 is a sensor which, according to its own on/off, detects the leading or trailing end of a document being fed along the bidirectional feed path 39. For example, by monitoring the number of rotations of the feed rollers 35A, 35B, 35C and 35D. After detection of the leading or trailing end of the document by the switchback sensor 55 through the number of steps of the encoder or motor 67, it is judged whether the trailing end of the document has passed through the crossing position 40 or not. By arranging the switchback sensor 55 at a position which is relatively near to the switchback roller 43 and exists on the feed-direction upstream side of the switchback roller 43, the feed precision of the switchback roller 43 can be enhanced further than the case in which the trailing end of the document is monitored according to the detect signal of the rear sensor 54.

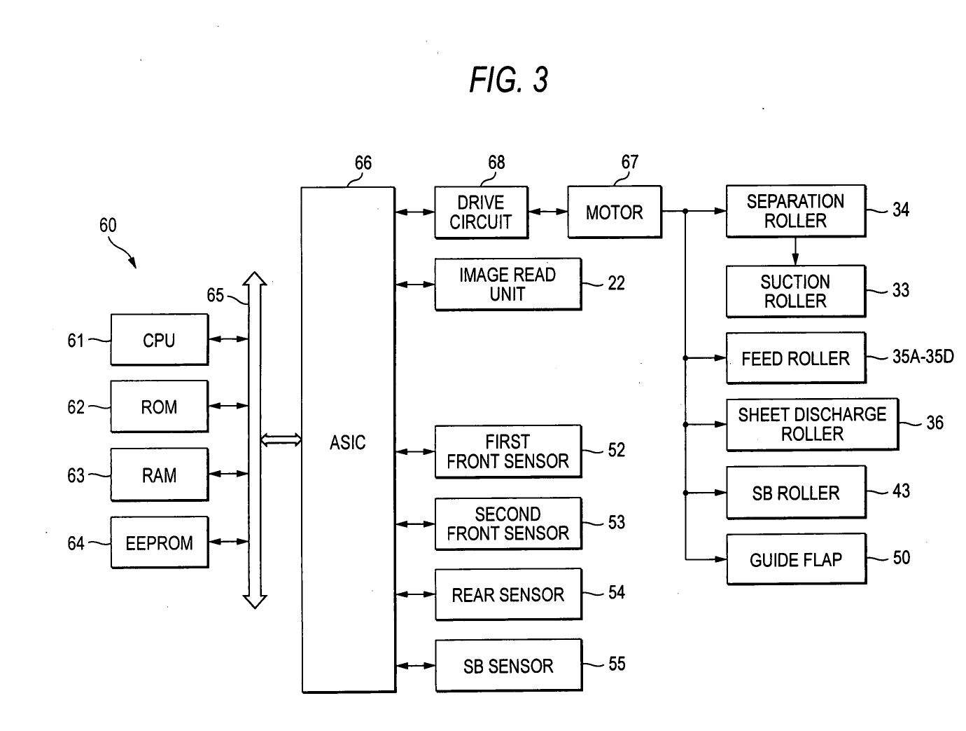

FIG. 3 shows the structure of the control part 60 of the image reading apparatus 1. The control part 60 is a part which controls not only the ADF 3, but also the whole operation of the image reading apparatus 1. The control part 60, as shown in FIG. 6, is structured as a microcomputer which is mainly composed of a CPU 61, a ROM 62, a RAM 63, and an electrically erasable and programmable ROM (EEPROM) 64, while the control part 60 is connected through a bus 65 to an application specific integrated circuit (ASIC) 66,

In the ROM 62, programs and the like are stored which are used to control various operations of the image reading apparatus 1 and ADF 3. The ROM 63 is used as a storage area or an operation area which temporarily stores therein various kinds of data used when the CPU 61 executes the above programs. The EEPROM 64 is a storage area which stores therein various settings and flags to be continuously stored even after the power supply is turned off. CPU 61, ROM 62, RAM 63 and EEPROM 64 cooperate together in realizing a drive control unit according to the invention.

The ASIC 66, according to an instruction from the CPU 61, generates a phase exciting signal to be electrically applied to the motor 67, applies this phase exciting signal to the drive circuit 68 of the motor 67, and electrically applies a drive signal to the motor 67 through the drive circuit 68, thereby controlling the rotation of the motor 67. The motor 67 is a motor which, through its rotation in both of the forward and backward directions, can apply a drive force to the suction roller 33, separation roller 34, feed rollers 35A, 35B, 35C, 35D, sheet discharge roller 36, switchback roller (SB roller) 43 and guide flap 50. The motor 67 serves as the drive source of the ADF 3.

The drive circuit 68 is used to drive the motor 67, and specifically, upon receiving an output from the ASIC 66, the drive circuit 68 generates an electric signal for rotating the motor 67. Upon receiving this electric signal, the motor 67 is rotated in a given rotational direction and the rotational force of the motor 67 is transmitted through the respective drive force transmission mechanisms to the suction roller 33, separation roller 34, feed rollers 35A, 35B, 35C, 35D, sheet discharge roller 36, SB roller 43, and guide flap 50, respectively.

An image read unit 22, which reads the images of a document being fed from the ADF 3 to the read position, is connected to the ASIC 66. Based on a control program stored in the ROM 62, the image read unit 22 reads the images of a document. Although not shown, a drive mechanism for reciprocating the image read unit 22 is also operated when an output signal from the ASIC 66 is applied thereto.

The first front sensor 52, second front sensor 53, rear sensor 54 and switchback sensor 55 are connected to the ASIC 66. In response to the on/off of the respective sensors, the CPU 61, based on the control program stored in the ROM 62, allows the ASIC 66 to output a given output signal to thereby operate the motor 67 and image read unit 22. The control part 60, as described above, when the feed-direction leading end of the document has arrived at a given position upstream in the feed direction of the connecting position 38 of the document feed path 32, allows the second front sensor 53 to detect the feed-direction rear end side of the document. When the second front sensor 53 is on, the control part 60 judges that the document is present, and when the second front sensor 53 is off, the control part 60 judges that no document is present. Thus, the control part 60 judges whether the document is longer than a given feed-direction length or not, thereby deciding the control of the document feed in the double-sided reading mode. The details of the control will be discussed later in detail.

Now, description will be given below of the image reading operation to be executed by the present image reading apparatus 1.

The image reading apparatus 1 not only can be used as an FBS but also can use the ADF 3. However, use of the image reading apparatus 1 as an FBS does not relate to the present invention specially and thus the detailed description thereof is omitted here. When using the ADF 3, it is considered that the document cover 4 is closed with respect to the document placement base member 2. The opening and closing of the document cover 4 can be detected by sensors disposed on the document placement base member 2, and when the document cover 4 is closed, the ADF 3 can be used. A document Gn to be read is placed on the sheet feed tray 30. The document Gn is placed on the sheet feed tray 30 in a so called face-up manner that the reading surface (first surface) of the document Gn faces upward. Also, the number of documents Gn may be one sheet or two or more sheets. For example, when reading the images of two or more sheets of documents Gn having the same size, the documents Gn are placed on the sheet feed tray 30 in such a manner that the first surface of the first document G1 faces upward, that is, the documents Gn are superimposed on top of one another in a so called face-up manner.

When a read start instruction is input to the image reading apparatus 1, the motor 67 is driven, so that the suction roller 33, separation roller 34, feed rollers 35A, 35B, 35C, 35D, sheet discharge roller 36 and switchback roller 43 are driven and rotated at their respective given timings. Also, the arm 29 is lowered down to thereby bring the suction roller 33 into pressure contact with the document G1 placed on the sheet feed tray 30. The documents Gn are separated one by one from the remaining documents and are fed into the document feed path 32, starting from the document G1 that is placed at the highest position and receives directly the rotation forces of the suction roller 33 and separation roller 34. The thus fed document Gn is guided by the document feed path 32 and is fed to the read position, where the images of the document Gn are read by the image read unit 22 standing by below the read position. The document Gn, the images of which have been read, is discharged to the sheet discharge tray 31. In such image reading operation, the feed path of the document Gn when the images of one side of the document Gn are read is different from that when the images of both sides of the document Gn are read. Whether the images of one side of the document On are read or the images of both sides of the document On are read is judged according to a one side reading mode (a one side reading feed mode) or a double-sided reading mode (a double-sided reading feed mode) which have been previously set before the read start instruction is input. The set reading modes are stored in the RAM 63 and are retained there for a given period of time before and after the image reading operation.

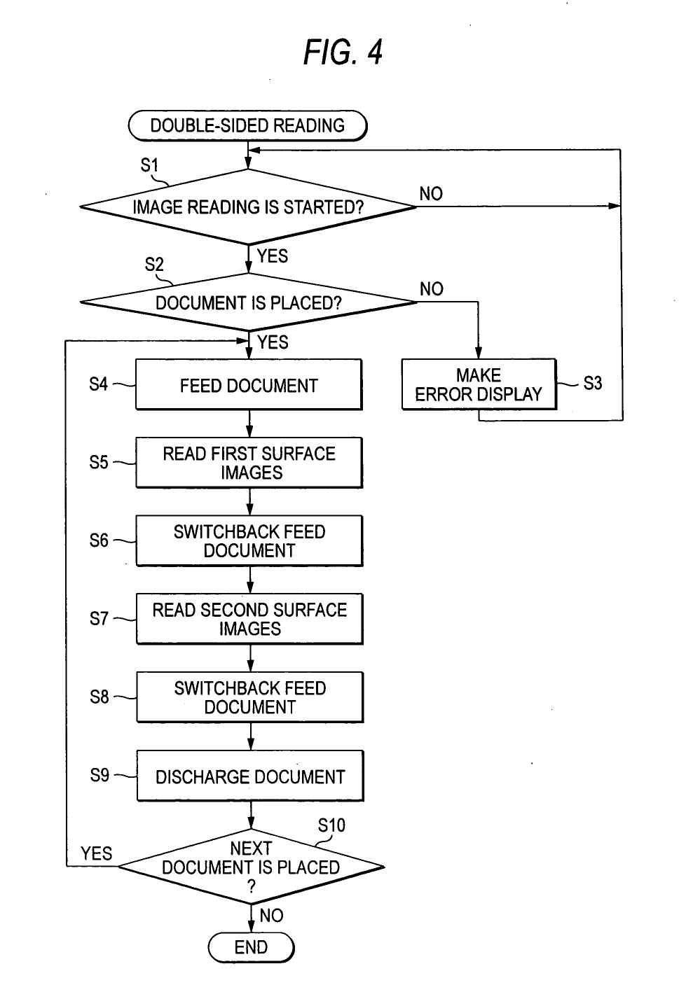

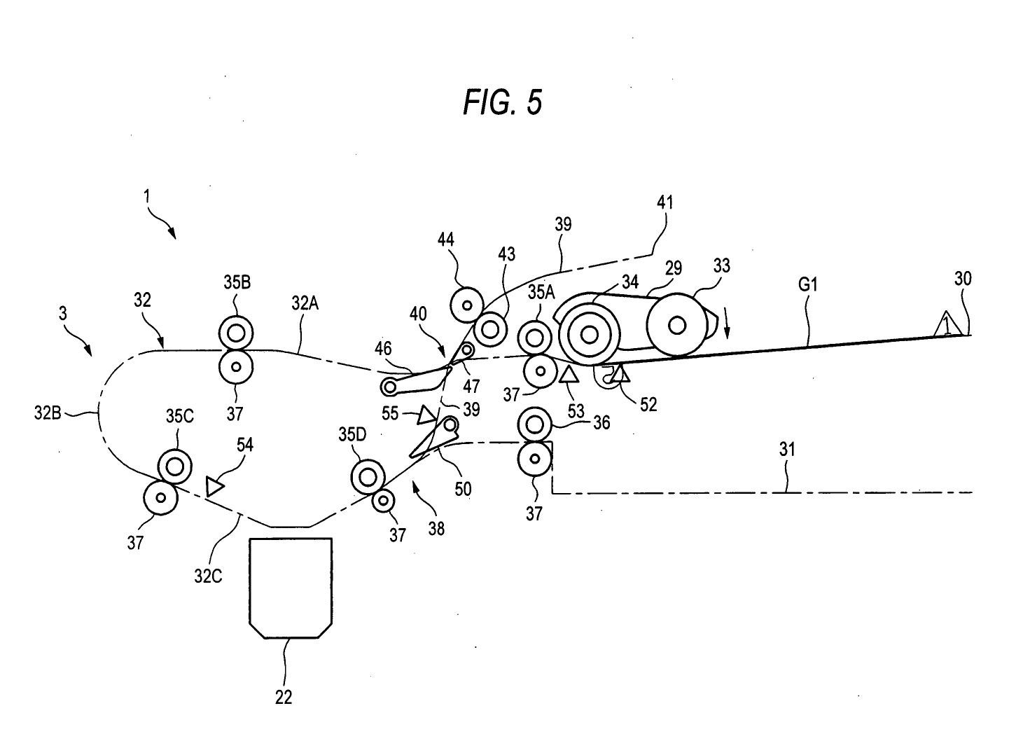

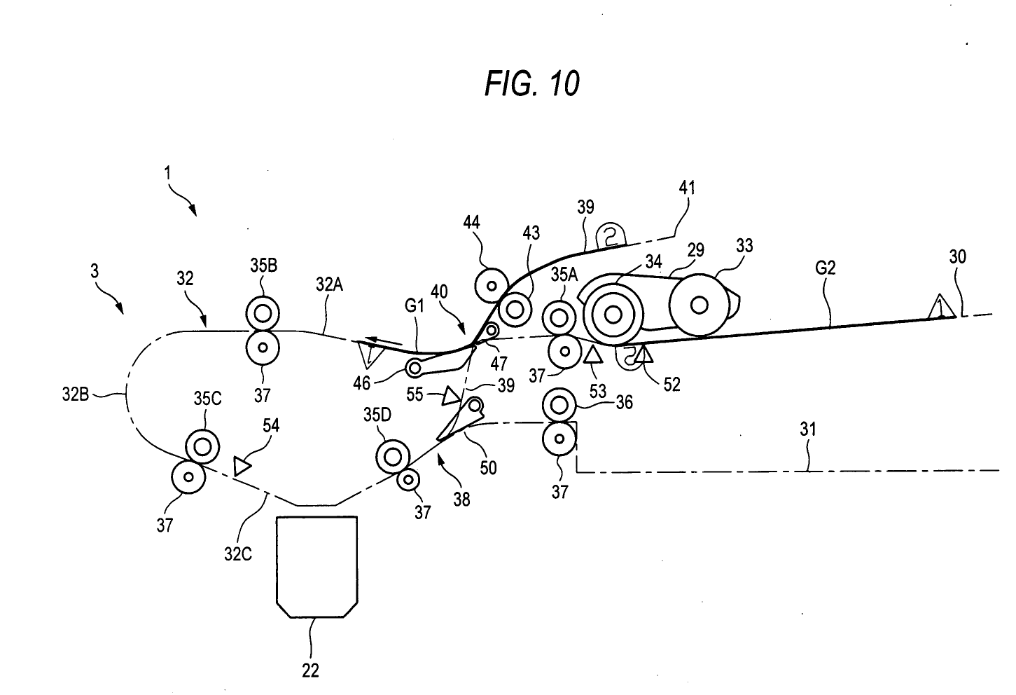

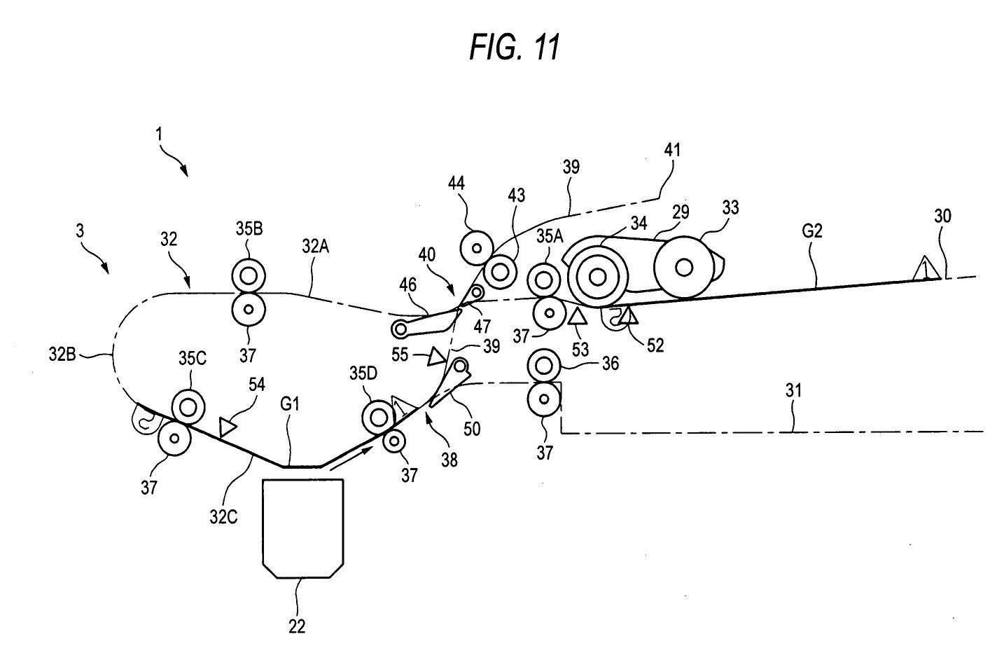

Now, FIG. 4 is a flow chart of the operation of the image reading apparatus 1 in the double-sided reading mode. Also, FIGS. 5 to 11 are respectively typical views of the feeding state of the document Gn in the double-sided reading mode. In the drawings, a surface shown by “1” in the document Gn is a first surface that is read firstly in the double-sided reading operation, whereas a surface shown by “2” is a second surface to be read later, and the first and second surfaces are completely opposite to each other.

Now, description will be given below of the double-sided reading operation to be executed by the image reading apparatus 1. When the one side reading mode is set in the image reading apparatus 1, the document G1 fed from the sheet feed tray 30 is U-turn fed along the document feed path 32 with its first surface opposite to the read position, whereby the images of only the first surface are read and the document G1 is then discharged to the sheet discharge tray 31. Such one side reading operation is a well-known operation and thus the detailed description thereof is omitted here.

Before the document Gn is fed, as shown in FIG. 5, the guide flap 50 is held at a position which allows the feed path in the connecting position 38 to be continuous from the read position side of the document feed path 32 to the sheet discharge tray 31 side. The guide flap 46 is held at a position which allows the feed path in the crossing position 40 to be continuous from the sheet feed tray 30 side of the document feed path 32 to the read position side. The guide flap 47 is held at a position which allows the feed path in the crossing position 40 to be continuous from the terminal end 41 side of the bidirectional feed path 39 to the read position side of the document feed path 32.

When a read start instruction input to the image reading apparatus 1 (S1) by depressing a start key, the control part 60 allows the first front sensor 52 to check whether the document Gn is placed on the sheet feed tray 30 or not (32). When it is judged that the document Gn is not placed on the sheet feed tray 30 (S2 (N)), the control part 60 makes an error display “no document” on the display portion of the image reading apparatus (S3). When it is judged that the document Gn is placed on the sheet feed tray 30 (S2 (Y)), the control part 60 drives the motor 67.

As the motor 67 is driven, a drive force is transmitted to the arm 29 and the arm 29 is thereby lowered down. As a result, the suction roller 33 is pressure contacted with the document Gn placed on the sheet feed tray 30. Also, the drive force of the motor 67 is transmitted to the suction roller 33 and separation roller 34, whereby the suction roller 33 and separation roller 34 are rotated in the feed direction and thus the document On is sent into the document feed path 32. When two or more sheets of documents Gn are placed on the sheet feed tray 30, there is a possibility that, as a document G1 existing at the highest position is fed, a document G2 just below the document G1 can be fed together with the document G1. However, the document G2 is stopped by a separation pad provided at the opposite position of the separation roller 34. Thus, the document G1 is fed to the document feed path 32 (S4).

In the document feed path 32, a drive force from the motor 67 is transmitted to the feed rollers 35A, 35, 35C, 35D and sheet discharge roller 36, whereby these respective rollers are rotated so as to feed the document Gn from the upstream side of the document feed path 32 to the downstream side thereof, that is, in the feed direction. The document G1 fed from the sheet feed tray 30 to the document feed path 32 is nipped between the feed roller 35A and pinch roller 37 and thus the rotation force of these rollers is transmitted to the document G1, whereby the document G1 is fed to the crossing position 40 along the document feed path 32. When the document G1 is fed to the document feed path 32, the second front sensor 53 is turned on.

Since the guide flap 47 closes the feed path from the sheet feed tray 30 side of the document feed path 32 to the crossing position 40, the document G1 fed to the crossing position 40 is contacted with the guide flap 47. As shown in FIG. 6, the guide flap 47 is rotated to the left in FIG. 6 in such a manner that it is pushed aside by the document G1 being fed along the document teed path 32. As a result, not only the feed path from the sheet feed tray 30 side of the document feed path 32 to the read position side is allowed to be continuous, but also the feed path to the terminal end 41 side of the bidirectional feed path 39 is closed. Also, the feed path to the connecting position 38 side of the bidirectional feed path 39 is closed by the guide flap 46. Therefore, the document G1 having arrived at the crossing position 40 from the sheet feed tray 30 side of the document feed path 32 is guided by the guide flaps 46 and 47 and is thereby fed to the read position side of the document feed path 32 without advancing in either direction of the bidirectional feed path 39.

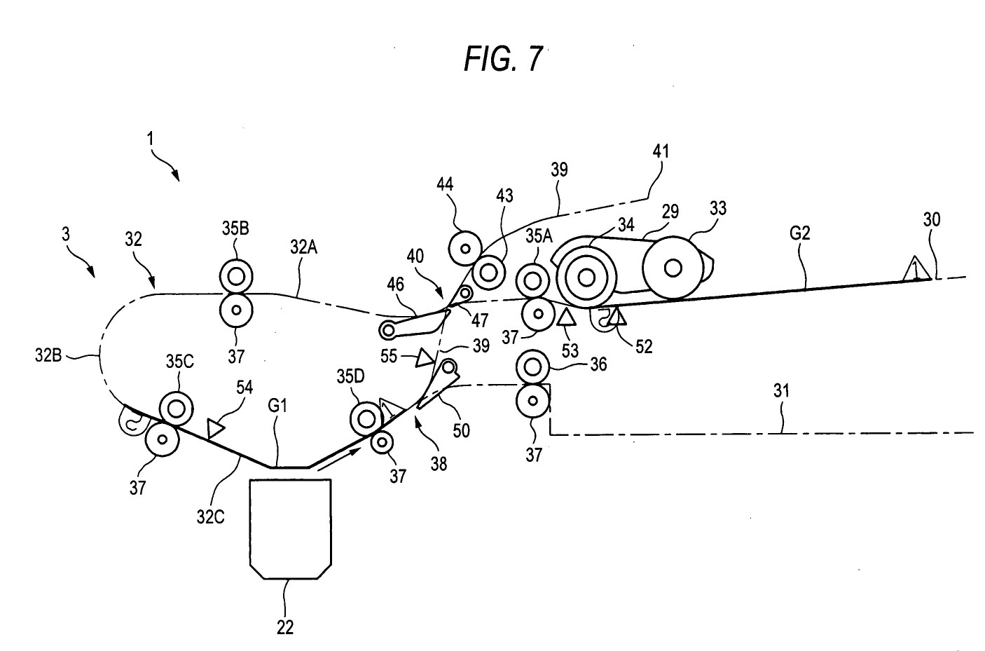

As shown in FIG. 7, the document G1 is fed in such a manner that it reverses downward along the curved portion 32B of the document feed path 32, while the rear sensor 54 detects the feed-direction leading end of the document G1 and is thereby turned on. Since the feed-direction leading end of the document G1 arrives at the read position after passage of a given time since it was detected by the rear sensor 54, the control part 60, when the rear sensor 54 is turned on and after passage of a given time, allows the image read unit 22 to apply a timing signal for start of reading to the image read unit 22 to operate the image read unit 22, thereby reading the images of the document G1 (SS). The document G1 passes through the read position with its first surface facing the image read unit 22, so that the images of the first surface of the document G1 are read by the image read unit 22. The rear sensor 54 turns off when it detects the feed-direction trailing end of the document G1. When the rear sensor 54 turns on, the control part 60, after passage of a given time, applies a timing signal for end of reading to the image read unit 22, to thereby end the image reading of the first surface of the document G1. Data on the images of the first surface of the document G1 read by the image read unit 22 are stored in a given area of the RAM 63.

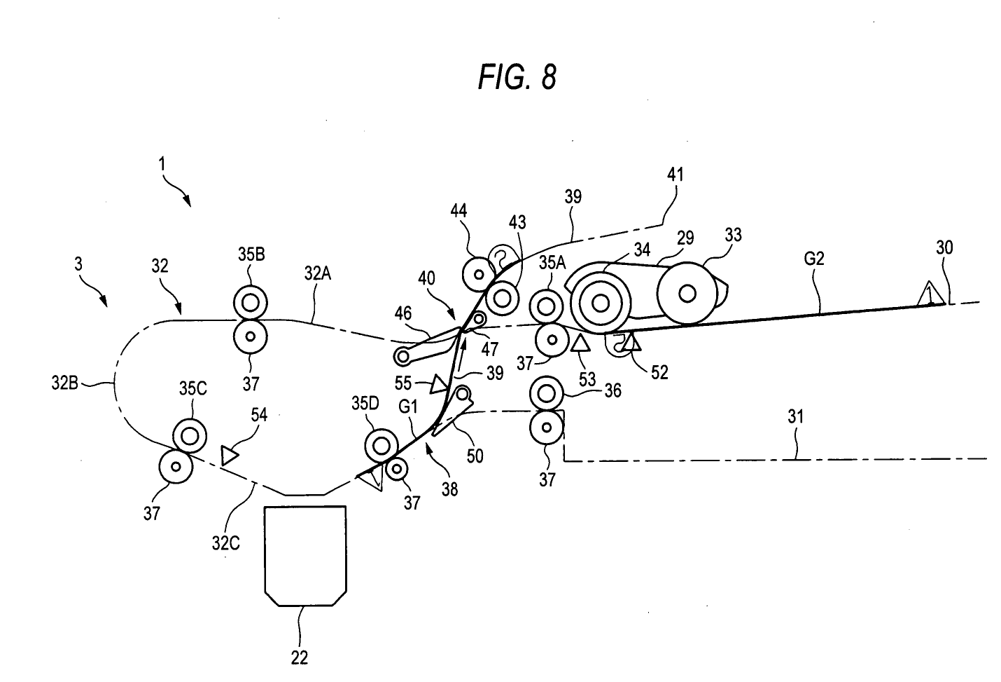

As shown in FIG. 8, the feed-direction leading end of the document G1, the first surface of which has been read, is guided by the guide flap 50 to advance along the connecting position 38 from the document feed path 32 to the bidirectional feed path 39, whereby it is switchback-fed (S6). The guide flap 50, for example, according to the rotation switching of the motor 67, is varied in position. The switchback sensor 55 detects the feed-direction leading end of the document G1 which has entered the bidirectional feed path 39, and is thereby turned on. The switchback roller 43, to which a drive force has been transmitted from the motor 67, is rotating in the pull-in direction.

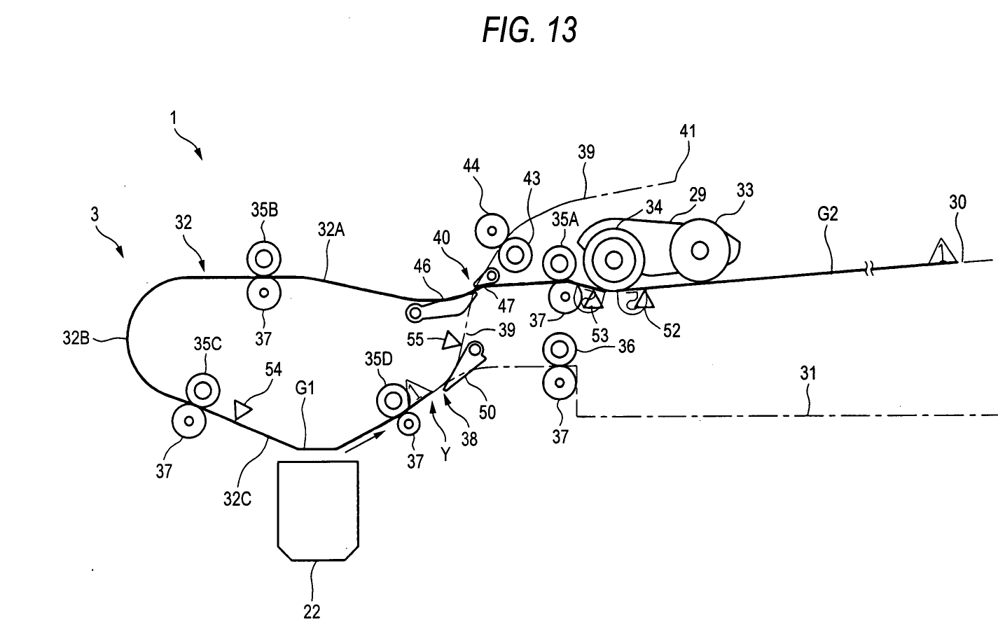

Since the guide flap 46 closes the feed path from the bidirectional feed path 39 to the crossing position 40, the feed-direction leading end of the document G1 having entered the bidirectional feed path 39 is contacted with the guide flap 46 when it arrives at the crossing position 40. The guide flap 46, as shown in FIG. 13, is rotated in such a manner that it pushes up the switchback flap 39 onto the feed-direction leading end of the document G1 to be fed, so that the guide flap 46 changes its position. As a result, the feed path from the connecting position 38 side of the bidirectional feed path 39 to the terminal end 41 side of the bidirectional feed path 39 is allowed to be continuous, and at the same time, the feed path to the read position side of the document feed path 32 is closed. Also, the feed path to the sheet feed tray 30 side of the document feed path 32 is closed by the guide flap 47. Therefore, the feed-direction leading end of the document G1, which has arrived at the crossing position 40 from the connecting position 38 side of the bidirectional feed path 39, is guided by the guide flaps 46 and 47 and is fed to the bidirectional feed path 39 without advancing to the document feed path 32. The feed-direction leading end of the document G1 is nipped between the switchback roller 43 and its associated pinch roller 44, and is fed to the terminal end 41 side of the bidirectional feed path 39 due to the pull-in-direction rotation of the switchback roller 43.

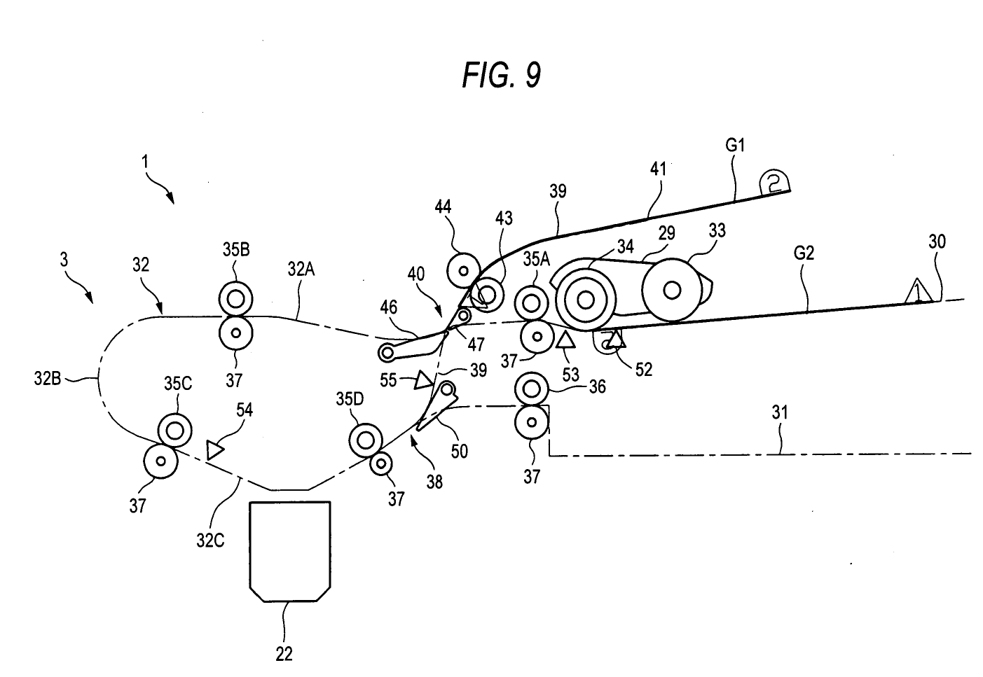

As shown in FIG. 9, after the feed-direction trailing end of the document G1 has completely entered the terminal end 41 side beyond the crossing position 40 of the bidirectional feed path 39, the control part 60 switches the rotation of the motor 67. The switchback sensor 55 detects the feed-direction trailing end of the document G1 being fed along the bidirectional feed path 39 and is thereby turned off, After passage of a given time, the feed-direction trailing end of the document G1 passes through the crossing position 40. Therefore, the control part 60 judges, from the detect signal of the switchback sensor 55 as well as from the counted feed distance or feed time by the feed roller 35D and switchback roller 43, that the feed-direction trailing end of the document G1 has completely entered the terminal end 41 side beyond the crossing position 40 of the bidirectional feed path 39. Since the document G1 passes through the crossing position 40 and parts away from the guide flap 46, the guide flap 46 is rotated downward to return to the crossing position.

When a portion of the document G1 projects from the terminal end 41 of the bidirectional feed path 39 to the outside of the ADF 3, the projecting portion of the document G1 is supported by the document support portion 42. Also, as the document G1 passes through the crossing position 40 and parts away from the guide flap 46, the guide flap 46 is rotated downward.

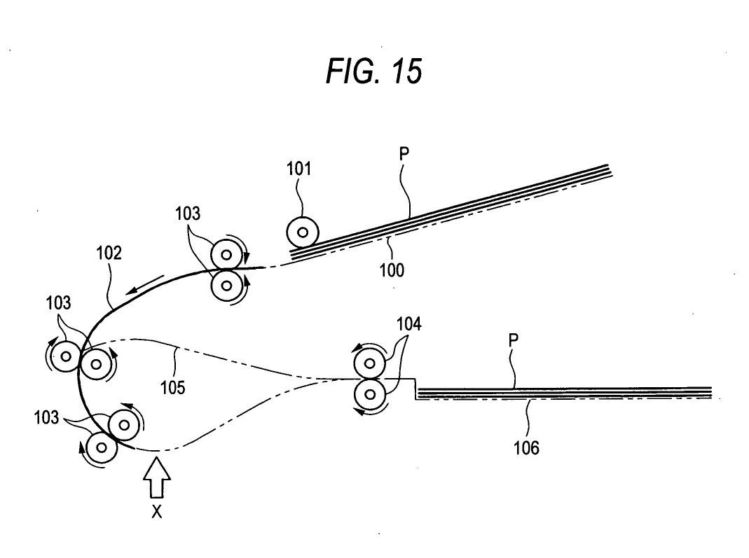

As shown in FIG. 15, the document G1, which has been returned from the bidirectional feed path 39, is contacted in the crossing position 40 with the guide flap 46. The guide flap 46 is prevented from rotating downward. Therefore, the feed path from the terminal end 41 side of the bidirectional feed path 39 to the read position side of the document feed path 32 is allowed to be continuous, and at the same time, the feed path to the connecting position 38 side of the bidirectional feed path 39 is closed. Also, the guide flap 47 closes the feed path to the sheet feed tray 30 side of the document feed path 32. Thus, the document G1 is guided by the guide flaps 46 and 47 and is fed from the terminal end 41 side of the bidirectional feed path 39 to the read position side of the document feed path 32 without entering the connecting position 38 side of the bidirectional feed path 39 or the sheet feed tray 30 side of the document feed path 32. The document G1 is returned to the upstream side of the read position of the document feed path 32 from the bidirectional feed path 39, whereby the document G1 is fed again along the document feed path 32 with the leading and trailing ends thereof reversed when compared with the state where the document G1 was initially fed along the document feed path 32. In this manner, the document G1 is switchback-fed (S6). The document G1 is thus fed along the document feed path 32 with its second surface facing the read position.

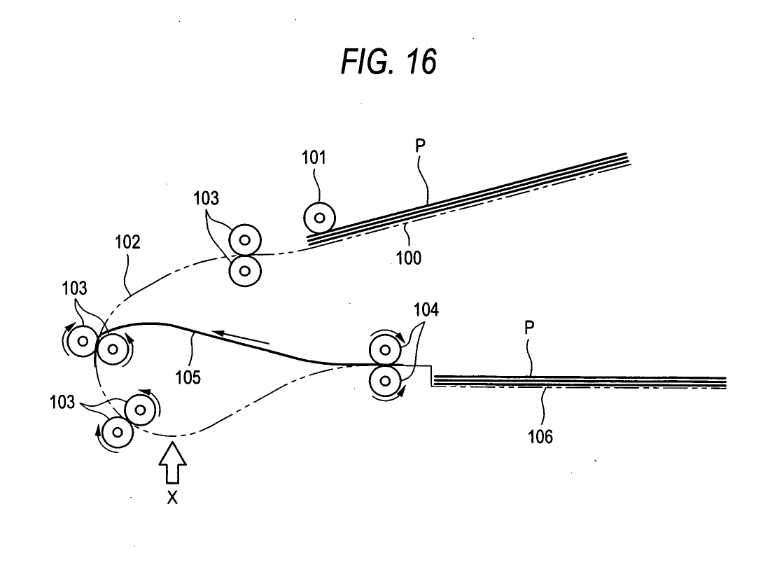

When the feed-direction leading end of the document G1 is detected by the rear sensor 54 and the present feed-direction leading end arrives at the read position, as shown in FIG. 16, the control part 60 allows the image read unit 22 to read the images of the second surface of the document G1 (S7). After the second surface thereof has been read, the feed-direction leading end of the document G1 is guided by the guide flap 50 and advances in the connecting position 38 from the document feed path 32 to the bidirectional feed path 39. When the feed-direction trailing end of the document G1 is detected by the rear sensor 54 and the present trailing end arrives at the read position, the control part 60 ends the image reading of the second surface of the document G1 by the image read unit 22. Data on the images of the second surface of the document G1 read by the image read unit 22 are stored in a given area of the RAM 63.

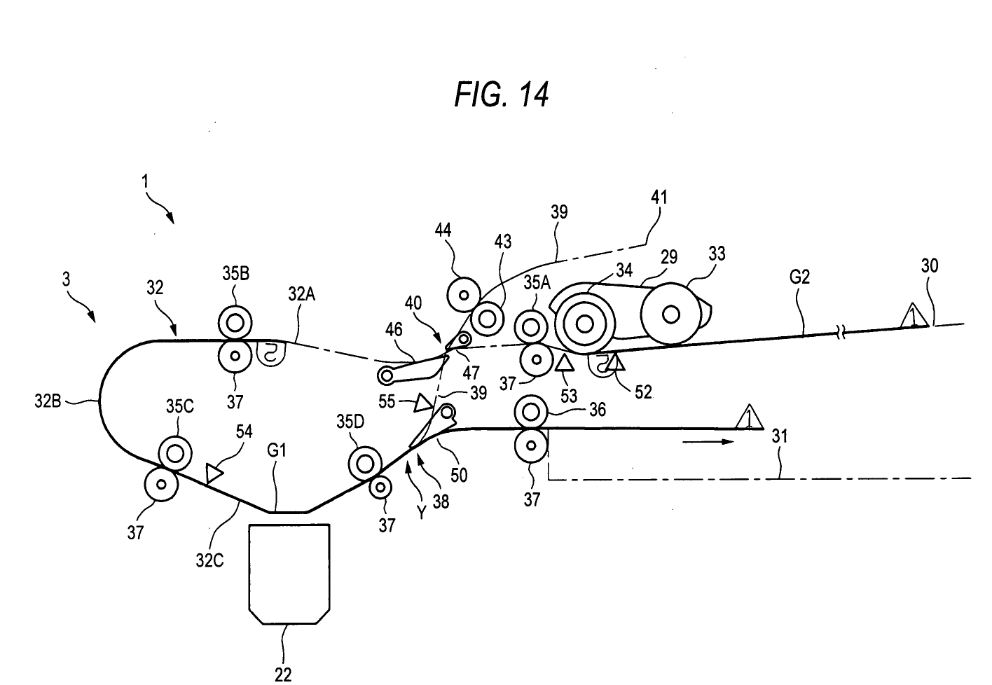

The feed-direction leading end of the document G1 having arrived at the crossing position 40, similarly to FIG. 13, pushes up the guide flap 46 to change the guide flap 46 and advances in the crossing position 40 to the terminal end 41 side of the bidirectional feed path 39. Similarly to FIG. 14, after the feed-direction trailing end of the document G1 has completely entered the terminal end 41 side beyond the crossing position 40 of the bidirectional feed path 39, the control part 60 switches the rotation direction of the motor 67 and rotates the switchback roller 43 in the return direction to thereby return the document G1 to the crossing position 40. Similarly to FIG. 15, the document G1 having returned from the bidirectional feed path 39 is guided by the guide flaps 46 and 47 and is fed from the terminal end 41 side of the bidirectional feed path 39 to the read position of the document feed path 32. Therefore, the document G1 is fed again to the document feed path 32 while the leading and trailing ends thereof are reversed again, that is, in the state where the document G1 was initially fed to the document feed path 32 (S8).

After then, the document G1 passes through the read position with its first surface facing the read position is guided by the guide flap 50 to the sheet discharge tray 31 side along the connecting position 38, and is then discharged by the sheet discharge roller 36 to the sheet discharge tray 31 with its first surface facing downward (S9). When a next document G2 is set on the sheet feed tray 30 (S10 (Y)), that is, when the first front sensor 52 is on, the control part 60 rotates the separation roller 34 in the feed direction. As a result, the document G2 set on the sheet feed tray 30 is fed to the document feed path 32, and similarly to the above, the images of both sides of the document G2 are read. When a next document is not present on the sheet feed tray 30 (S10 (N)), the control part 60 ends the double-sided reading operation.

In the present aspect, description has been given of the double-sided image reading operation by the image reading apparatus 1, assuming that each document is discharged to the sheet discharge tray 31 in a state where the order of two or more documents Gn placed on the sheet feed tray 30 is maintained. However, when it is not necessary to match the order of the documents Gn placed on the sheet feed tray 30 to the order of the documents Gn discharged to the sheet discharge tray 31, after the documents Gn are fed with their respective second surfaces facing the read position, without moving the documents Gn back to the bidirectional feed path 39 again, the documents Gn may be fed along the connecting position 38 to the sheet discharge tray 31 side to thereby discharge the documents Gn to the sheet discharge tray 31. In this case, although the order of the documents Gn in the sheet discharge tray 31 is not maintained, the last bidirectional feeding operation can be saved, thereby being able to shorten the time necessary to read the images of both sides of the documents Gn.

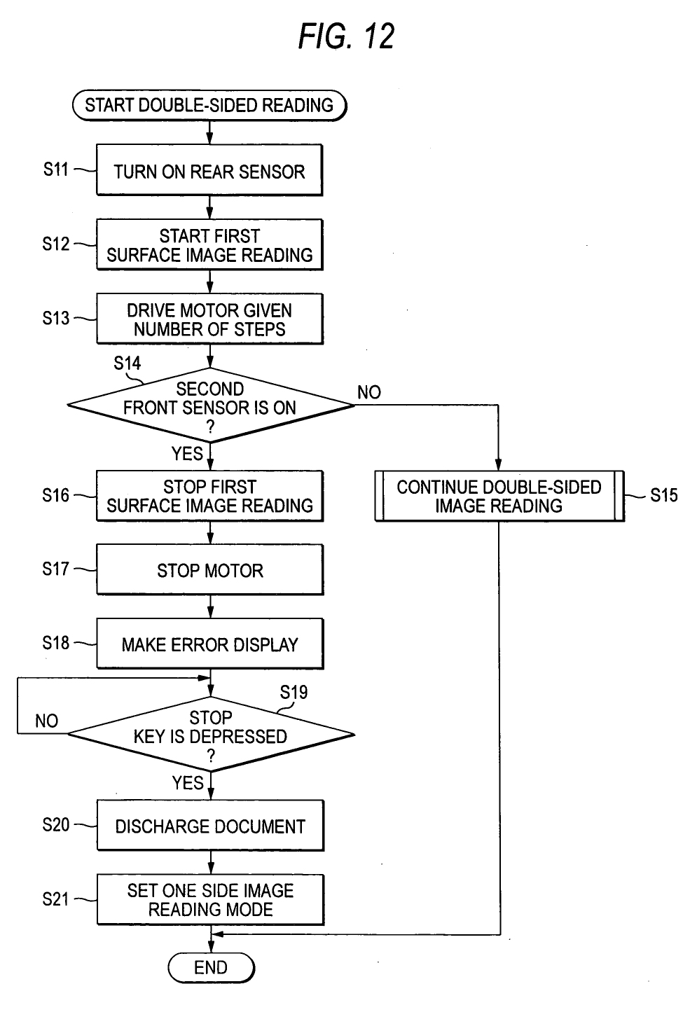

In the double-sided reading operation, the control part 60 checks whether the document Gn fed from the sheet feed tray 30 can be read for both sides thereof or not. Now, description will be given below of the checking method. FIG. 12 is a flow chart of a method for checking whether the document Gn is a document the both sides of which can be read or not. FIG. 13 is a typical view of a state for detecting the feed-direction length of the document G1. FIG. 14 is a typical view of a state for discharging the document G1 both sides of which cannot be read.

As described above, in the double-sided reading operation, the feed-direction leading end of the document G1 fed from the sheet feed tray 30 to the document feed path 32 is detected by the rear sensor 54, thereby turning on the rear sensor (S11). When the feed-direction leading end of the document G1 arrives at the read position, the control part 60 operates the image read unit 22 to thereby read the images of the first surface of the document G1 (S12).

The feed-direction leading end of the document G1 having passed through the read position is then fed toward the connecting position 38. The control part 60, as shown in FIG. 13, when the feed-direction leading end of the document G1 arrives at a given position Y upstream in the feed direction of the connecting position 38, checks whether the second front sensor 53 detects the feed-direction trailing end of the document G1 or not, that is, whether the second front sensor 53 is on or off. As described above, the control part 60, according to the amount of rotation of the motor 67 after the rear sensor 54 detects the feed-direction leading end of the document G1 and thereby turns on, can check whether the feed-direction leading end of the document G1 has arrived at the read position or not. Similarly, the control part 60, after the rear sensor turns on, drives the motor 67 a given number of steps (S13), whereby the control part 60 can judge that the feed-direction leading end of the document G1 has arrived at the given position Y.

As described above, the distance from the second front sensor 53 to the connecting position 38 of the document feed path 32 is longer than the feed-direction length of a document both sides of which can be read by the image reading apparatus 1. Therefore, in order that the distance from the second front sensor 53 to the given position Y can be made equivalent to the feed-direction length of the maximum-size document both sides of which can be read by the image reading apparatus 1, the given position Y can be set arbitrarily upstream in the feed direction of the connecting position 38. For example, when the maximum-size document both sides of which can be read by the image reading apparatus 1 has an A4 size in longitudinal feeding, the distance from the second front sensor 53 to the given position Y is 297 mm, and for a legal size in longitudinal feeding, the distance is set for 355 mm. In this manner, the given position Y can be set to the size of the maximum document both sides of which can be read. The maximum size of a document both sides of which can be read by the image reading apparatus can be determined by a loop-shaped feed distance extending from the crossing position 40 of the document feed path 32 through the read position, connecting position 38 and bidirectional feed path 39 to the crossing position 40. Suppose that a document on having a feed-direction length longer than the loop-shaped feed distance advances from the connecting position 38 of the document feed path 32 into the bidirectional feed path 39 and then arrives at the crossing position 40, there is a possibility that, the feed-direction leading end side of the document Gn may be contacted with the feed-direction trailing end side of the document Gn to thereby cause jammed sheets or damaged document Gn in the crossing position 40. Therefore, a document having a feed-direction length shorter than the above-mentioned loop-shaped feed distance is considered as a document which can be fed for double-sided reading by the ADF 3.

When the feed-direction leading end of the document G1 arrives at the given position Y, if the second front sensor 53 is off (S14 (N)), the control part 60 judges that the document G1 is a document both sides of which can be read. In this case, the control part 60 continues the first surface image reading operation of the document G1, and as shown in FIG. 4, carries out the bidirectional feeding operation, second surface image reading operation, bidirectional feeding operation and sheet discharging operation (S15).

As shown in FIG. 13, for the document G1 which is longer than the double-sided readable feed-direction length, when the feed-direction leading end of the document G1 arrives at the given position Y, the second front sensor 53 turns on (S14 (Y)). In this case, the control part 60 stops the image reading of the first surface of the document G1 (S16) and also stops the driving of the motor 67 (S17). Data on the images of the first surface already stored in the RAM 63 are erased.

Next, the control part 60 makes an error display on the liquid crystal display portion 12 of the image reading apparatus 1. The error display may be given by displaying using a given language, for example, to the effect that the document is longer than the double-sided readable document and also to the effect that a stop key should be depressed to remove the error. This makes it possible for a user to recognize easily that the document G1 cannot be fed in the double-sided reading feed mode. An error notice according to the invention is not limited to such screen display but other methods can also be employed, provided that they can act on the five senses of the user, for example, an LED may be turned on or an error sound may be generated.

When the stop key is depressed (519 (Y)), the control part 60 drives the motor 67 to thereby change the position of the guide flap 50 into an position for guiding the document G1 to the sheet discharge tray 31 side. As shown in FIG. 14, the control part 60 drives the feed rollers 35A˜D and sheet discharge roller 36 to thereby discharge the document G1 to the sheet discharge tray 31 (S20). As shown in FIG. 13, since the feed-direction leading end of the document G1 has not arrived at the connecting position 38, even when the guide flap 50 is changed in position, the document G1 is prevented against damage. Also, the document G1, when the feeding operation thereof is resumed, can be guided by the guide flap 50 and thus is able to move to the sheet discharge tray 31 side.

The control part 60, after the document G1 is discharged to the sheet discharge tray 31, sets the one side reading feed mode (S21). As described above, in the image reading apparatus 1, the double-sided reading mode is set before the double-sided image reading operation is started, and the feed mode is retained for a given time even after end of the double-sided reading operation. Suppose that the control part 60 does not set the one side reading mode, even after the document G1 is discharged to the sheet discharge tray 31, the double-sided reading mode is retained. Therefore, when the user does not set the one side reading mode in the image reading apparatus 1 but starts the reading of the images of the document G1, there is made an error display again, whereby the document G1 is discharged to the sheet discharge tray 31. The control part 60, after the document G1 is discharged to the sheet discharge tray 31 (S20), sets the one side reading feed mode automatically, thereby being able to prevent the document G1 from being fed again in the double-sided reading feed mode.

As described above, according to the present image reading apparatus 1, since the second front sensor 53 is disposed upstream of the connecting position 38 of the document feed path 32 in the feed direction and the feed distance from the second front sensor 53 to the connecting position 38 is longer at least than the feed-direction length of a document Gn both sides of which can be read, before the leading end of the document On fed from the sheet feed tray 30 to the document feed path 32 arrives at the connecting position 38, based on the detect signal of the second front sensor 53, the feed-direction length of the document Gn can be judged. This makes it possible to judge, before the document Gn advances into the bidirectional feed path 39, whether the document Gn being fed is a document both sides of which can be read or not. This can prevent the document On against damage or can prevent the sheets from being jammed.

According to the present aspect, the control part 60, after the document G1 is discharged to the sheet discharge tray 31, sets the one side reading feed mode (S21). However, when a default setting in the image reading apparatus 1 is the one aide reading mode, the control part 60 may execute a default setting after discharge of the document G1. Also, according to the present aspect, in order to remove the error display (S18), the stop key is depressed (S19). However, such operation is optional, for example, the control part 60, after the error display (S18), may immediately discharge the document G1 (S20)

What is claimed is:

1. A document feeder comprising:
an inlet;
an outlet;
an input transfer path configured to guide a document during transfer from the inlet passed a scanning point to an end point positioned above the inlet;
an intermediate transfer path configured to guide the document during transfer from the end point passed the scanning point to the end point again;
an output transfer path configured to guide the document during transfer from the end point passed the scanning point to the outlet;
a sensor disposed at downstream of the scanning point; and
a controller determines whether the document can be transferred, based on the signal of the sensor.

2. The document feeder according to claim 1, wherein
the intermediate feed path crosses the input feed path at a crossing position.

3. The document feeder according to claim 1, the crossing position disposed at the upstream of the scanning position.

4. The document feeder according to claim 1, further comprising
the controller including;
a first mode that feeds the document through the input transfer path and the output transfer pat; and
a second mode that feeds the document through the input transfer path, the intermediate transfer path and the output transfer pat, wherein
in the second mode, the controller determines whether a length of the document is longer than a predetermined length base on the signal, and the document is discharged to the outlet based on the determination.

5. The document feeder according to claim 4, wherein
the controller sets the first mode, in accordance with discharging the document.

6. The document feeder according to claim 4, wherein the controller sets the first mode, in accordance with the signal.

7. The document feeder according to claim 3, wherein
the controller indicates an error notice, based on the signal.

8. The document feeder according to claim 1, wherein:
the controller determines whether a length of the document is longer than a predetermined length; and
the predetermined length is equivalent to a distance extending from a crossing position, where the intermediate feed path crosses the input feed path, through the read position to the crossing position.

9. The document feeder according to claim 4,wherein
the predetermined length is equivalent to a distance extending from a crossing position, where the intermediate feed path crosses the input feed path, through the read position to the crossing position.
